(19) United States
(12) Patent Application Publication
(10) Pub. No.: US 2006/0274408 A1
(43) Pub. Date: Dec. 7, 2006

(54) Microscope for diffracting objects

(76) Inventor: Vincent Lauer, Nogent sur Mame (FR)

Correspondence Address: VINCENT LAUER, 1 VILLA DE BEAUTE, NOGENT SUR MARNE, 94130, FR

(21) Appl. No.: 11/483,274

(22) Filed: Jul. 10, 2006

Related U.S. Application Data
(63) Continuation of application No. 10/415,897, filed on Oct. 21, 2003, now abandoned.

(30) Foreign Application Priority Data
Nov. 6, 2000 (FR) 0014160
Feb. 13, 2001 (FR) 0101908
Mar. 9, 2001 (FR) 0103215
Mar. 22, 2001 (FR) 0103861

(51) Int. Cl. G02B 21/06

(52) U.S. Cl. 359/386

(57) ABSTRACT

The invention concerns a microscope for observing diffracting objects comprising a laser beam (2000) reflected by a first surface of mobile mirrors (2003) and (2007), passing through the condenser (2011), the sample (2040), the lens (2013), reflected by a second surface of mobile mirrors, passing through a filtering device (2019) and third-wave palates (2022) (2027) applying phase shifts only to the non-diffracted part of the wave, and detected by the cameras (2024) (2029) (2032). The invention is applicable in fast three-dimensional and two-dimensional microscopy, in biology and the study of materials.

### RELATED APPLICATIONS

This application is a continuation of U.S. application Ser. No. 10/415,897 which was the National Stage of International Application No PCT/FR01/03394 filed Nov. 2, 2001. The entire contents of both these applications is expressly incorporated herewith by reference thereto.

### FIELD OF THE INVENTION

The invention relates to a microscope for the observation of diffracting objects.

### BACKGROUND

High resolution images, with very low or very high depth of field, can be obtained using the microscope described in “Observation of biological objects using an optical diffraction tomographic microscope”, by Vincent Lauer, proceedings of SPIE vol.4164 p.122-133, and in patent WO99/53355.

However, the apparatus described in the above publication cannot readily be used for real time imaging.

In a microscope operating in transmission and in which the illuminating wave is not focused on a particular point of the observed object, it is useful to be able to modify the diffracted part of the illuminating wave independently of the non-diffracted part of that wave. The phase contrast microscope, for example, is based on this principle. However, in a phase contrast microscope, the phase shift applied using a phase ring affects not just the non-diffracted part of the wave, but also a considerable part of the diffracted wave. This results in significant disturbances of the image, as for example with the halo phenomenon or the fact that the depth of field is poorly defined and higher than what it is in bright field, with the quality of image in general being much poorer than that obtained using the microscope described in proceedings of SPIE vol.4164 p.122-133.

In bright field, the image formed by a conventional microscope also has an effective resolution lower by a half than the theoretical maximum reached for example in proceedings of SPIE vol.4164 p.122-133.

### SUMMARY OF THE INVENTION

The subject of the present invention is a microscope whose performance in terms of resolution and depth of field is similar to that of the microscope described in proceedings of SPIE vol.4164 p. 122-133, but that allows images in real time and in colour to be obtained, at an acceptable cost, that can be observed using either a camera or an eyepiece.

The invention consists of a microscope operating in transmission, including a light source and a condenser that allow an observed object to be illuminated using a light beam not focused on the observed object, and a microscope objective collecting the light beam after it has passed through the observed object, characterized by the fact that it includes:

a beam deflector placed between the lighting source and the condenser, to vary the direction of the light beam in the observed object,

at least one lens to focus, at a first focal point of a first focal plane, the part not diffracted by the observed object of the light beam having passed through the observed object and the microscope objective,

a first filtering device placed in the first focal plane, to apply a modification of phase and/or of attenuation and/or of polarization, which varies within the first focal plane,

at least one first mobile mirror placed on the path of the light beam having passed through the observed object, between the objective and the first spatial filtering device, to modify the direction of the light beam, so that the direction of the light beam, after reflection on the mobile mirror, is independent of the direction of the light beam in the observed object, and so that the first focal point is fixed.

Owing to the fact that the non-diffracted part of the light beam reaches a fixed point of the first filtering device, such a device allows various filtering operations to be carried out on this beam that would be impossible in a plane where this beam reaches a mobile point.

According to a characteristic of the invention, the beam deflector preferably comprises at least one second mobile mirror, connected to said first mobile mirror or forming part of said first mobile mirror. Indeed, this solution avoids having to synchronize the beam deflector and the first mobile mirror, thus considerably simplifying the system.

According to a characteristic of the invention, the filtering device is placed in a plane conjugate with the image focal plane of the microscope objective. Indeed, this solution allows a light beam to be used that is parallel in the observed object and that focuses at a point of the focal plane that, on condition that suitable correction of aberrations is made, can have a diffraction-limited width.

The filtering device is used to improve or modify the image in various ways. For example, and according to a characteristic of the invention, the transmissivity of the first filtering device depends on the distance to the optical axis, and is an increasing function of the distance to the optical axis. This means resolution can be improved. According to another characteristic of the invention, the first filtering device includes a means to apply a phase shift between, on the one hand, the part of the light beam that passes through a central point coinciding with the first focal point and, on the other hand, the part of the light beam that does not pass through the central point. This allows, for example, a phase contrast image to be generated, or several images affected by different phase shifts between the non-diffracted part of the light beam, and the diffracted part of the light beam to be generated. For example, the phase shift can be generated using an extra thickness on a glass window. According to another characteristic of the invention, the first filtering device includes a means to attenuate the part of the beam that passes through a central point coinciding with the first focal point. This allows the image's contrast to be increased. For example, the means for attenuation can consist of an absorbing element included in the first filtering device.

According to another characteristic of the invention, the light beam reaching the first filtering device is polarized, and the first filtering device includes:

a means to polarize differently the wave passing through, on the one hand, a central point coinciding with the first focal point and, on the other hand, the rest of the filtering device, so that polarization of the part of the light beam that passed through the central point differs from polarization of the part of the light beam that passed through the rest of the filtering device

at least one polarizer passed through by the beam having passed through the first filtering device, to make the part of the light beam that passed through the central point interfere with the part of the light beam that passed through the remainder of the filtering device.

This solution makes it possible to implement contrast that varies, for example, according to the polarizer orientation. According to a characteristic of the invention complementary to the previous one, the microscope includes at least one retardation plate placed on the path of the light beam between the first filtering device and the polarizer, to modify the phase shift between the beam having passed through the central point and the beam having passed through the remainder of the filtering device. This retardation plate allows, for example, a variable phase contrast to be obtained. If several plates are present, it can also allow several images to be obtained that differ in the phase difference between the non-diffracted part of the beam and the diffracted part of the beam.

A shortcoming of conventional microscopes is that the image produced does not depend in linear fashion on the characteristics of the observed object, except if contrast is particularly weak. According to the invention, and in order to solve this problem, the microscope includes:

at least three sensors on which the part of the light beam that was diffracted by the observed object interferes with the part of the light beam that was not diffracted by the observed object,

means to apply a first phase shift between, on the one hand, the part of the light beam that was diffracted by the observed object and that reaches a first sensor, and, on the other hand, the part of the light beam that was not diffracted by the observed object and that reaches said first sensor,

means to apply a second phase shift, different from the first phase shift, between on the one hand, the part of the light beam that was diffracted by the observed object and that reaches a first sensor, and, on the other hand, the part of the light beam that was not diffracted by the observed object and that reaches said first sensor.

This allows at least three interference figures to be produced to calculate a complex image depending in linear fashion on the characteristics of the observed object.

Where no special precautions are taken, the non-diffracted part of the beam, after reflection on the first mobile mirror, has a fixed direction and is particularly intense. If observation is made directly using eyepieces, the presence of an intense laser beam of constant direction can cause injury to the eye.

Moreover, for the first mobile mirror not to cause displacement of the image plane, it needs to be placed exactly in this plane. This complicates the optical system and makes it particularly sensitive to errors in position of the mobile mirror as also to speckle problems.

According to a characteristic of the invention, these problems are solved using a third mobile mirror allowing the direction of the light beam to be modified after it has been reflected on the first mobile mirror. This third mobile mirror is preferably connected to the first mobile mirror or forms part of the first mobile mirror. It can be used to vary the direction of the beam as it comes out of the device and compensate for displacement of the image plane produced by the first mobile mirror. To ensure that this compensation is effective, the microscope will still, however, need to include optical means so that an image of the observed object, after reflection by the first mobile mirror and the third mobile mirror, remains fixed. The third mobile mirror can, for example, be an opposite face of the first mobile mirror. The optical means so that an image of the observed object, after reflection by the first mobile mirror and the third mobile mirror, remains fixed, may, for example, comprise, according to a version of the invention, the following:

two lenses or groups of lenses, separated by a focal plane of the light beam,

an odd number of fixed mirrors deviating the beam in a first deviation plane, and an odd number of fixed mirrors deviating the beam in deviation planes orthogonal to the first deviation plane.

The first filtering device can be used to modify contrast and improve resolution and quality of the image, but it cannot be used, for example, to improve depth of field. According to a characteristic of the invention, the characteristics of the image can be modified or improved using a second filtering device

placed in a second focal plane of the light beam, reached by said light beam after passing through the microscope objective and before reflection by said first mobile mirror,

allowing modification of phase and/or attenuation and/or variable polarization to be applied in the second focal plane.

In particular, and according to a characteristic of the invention, the depth of field of the image can be increased if the second filtering device lets through the light reaching an elliptic band and stops the light that does not reach this elliptic band. According to another characteristic of the invention, the second spatial filtering device includes means to let the light reaching one or the other of two distinct elliptic bands pass alternately. The two alternately produced images each constitute one projection along a different direction, and the combination of these two images yields a stereoscopic vision.

Other characteristics and advantages of the invention will appear during the description that follows of several of its embodiments, given as non-restrictive examples as illustrated by the attached drawings.

### BRIEF DESCRIPTION OF THE DRAWINGS

FIG. 1 is a general diagram of a first embodiment.

FIG. 2 is a diagram of a pierced half-wave plate used in this embodiment.

FIG. 3 shows the path from the point of impact of the illuminating wave in a plane conjugate with the image focal plane of the objective, during the sensor integration time, to obtain a section of the observed object using this microscope.

FIG. 4 shows in section the two-dimensional frequency representation obtained by Fourier transform of the image obtained for one given plane illuminating wave, as well as the part of the three-dimensional frequency representation of the observed object of which it is the projection.

FIG. 5 shows a lighting system that can be used to replace the laser.

FIG. 6 shows a detection system with a camera that can be used to replace the detection system using three cameras described in FIG. 1.

FIG. 7 shows an elliptic mask used to obtain a projection of the observed object.

FIG. 8 shows a detection system without wave plates that can be used to replace the detection system described in FIG. 1.

FIG. 9 shows a detection system with one camera placed in a plane conjugate with the image focal plane of the objective.

FIG. 10 is used as a basis to calculate the characteristics of the elliptic bands used on the mask of FIG. 7.

FIG. 11 shows the mask of FIG. 7 to scale and for a particular embodiment.

FIG. 12 shows a filter plate to attenuate the non-diffracted part of the wave for the case where the mask in FIG. 7 is used.

FIG. 13 shows a plate generating a phase shift of the non-diffracted part of the illuminating wave.

FIG. 14 shows a detection system with a camera in which the image acquired can be directly displayed on a screen.

FIG. 15 shows a device for direct observation using an eyepiece.

FIG. 16 shows a side view of an assembly with three mirrors as also shown in FIG. 17.

FIG. 17 shows an improved embodiment, more particularly adapted to direct observation using eyepieces.

FIG. 18 shows the electrodes of a polarization rotator used for stereoscopic observation.

FIG. 19 shows the frequency response of a bright field microscope.

In the following text, the term “lens” may refer either to a simple or compound lens, generally designed to minimize aberrations.

Optical systems can be developed in various ways. To facilitate system design and understanding of the diagrams, we shall use alternation between spatial planes, indicated by the letter (E) on the diagrams, and frequency planes, indicated by the letter (F) on the diagrams. A spatial plane will be defined as an image plane such that a plane wave in the observed object is plane in the spatial plane. A frequency plane will be defined as a plane conjugate with the image focal plane of the microscope objective, such that a wave centred on a point of an image plane is plane in the frequency plane. An image plane is a plane in which a point of the observed object, onto which the objective and the condenser are focused, has a point image. A beam that is parallel to the passing through of the observed object is focused at a point of the image focal plane of the objective and of each frequency plane.

Alternations of spatial (E) and frequency (F) planes used in the description do not constitute a limitation of the invention and a functional system can be developed that does not include such planes. The alternation of spatial and frequency planes is only one particularly simple embodiment of the invention.

### First Embodiment

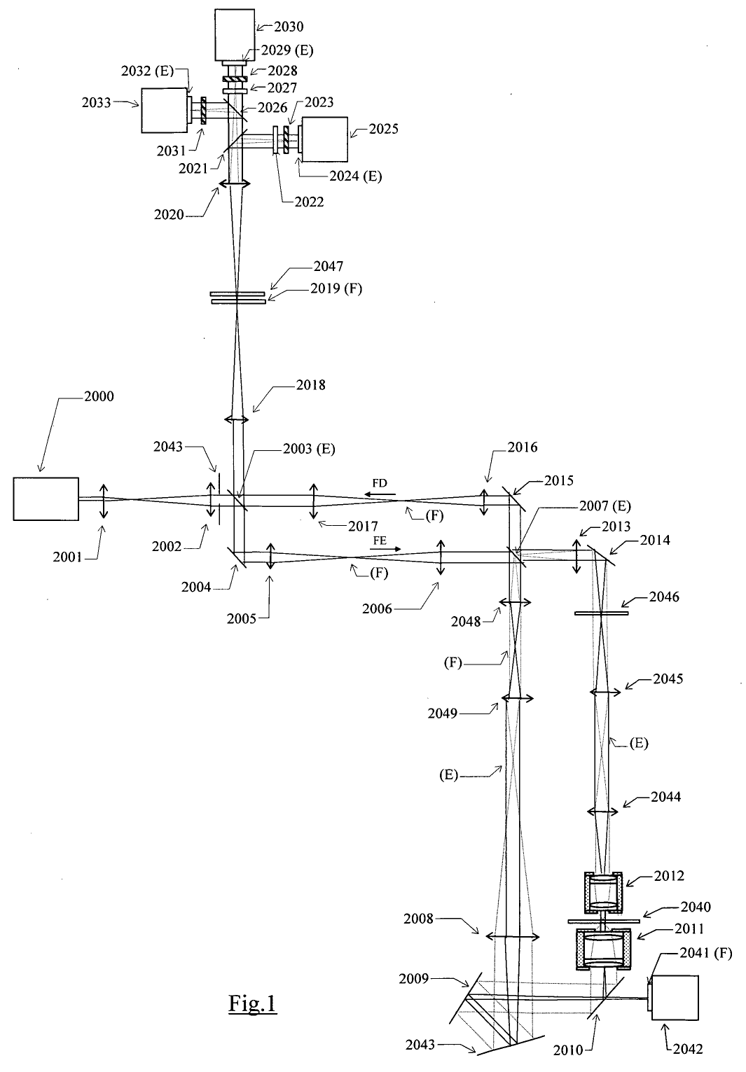

FIG. 1 is a general diagram of the first embodiment. Solid lines show the path of a beam that is parallel when it passes trough the observed object. The path of a beam coming from a point of the observed object is shown as a dotted line on some parts of the figure.

A light beam from laser 2000 polarized orthogonally to the plane of the figure is broadened by a beam expander comprising lenses 2001 and 2002. It passes through the field diaphragm 2043. It then reaches galvanometric mirror 2003 that reflects it towards fixed mirror 2004. Galvanometric mirror 2003 is mobile in rotation about an axis comprising its centre and oriented orthogonally to the plane of the figure. After reflection on 2004 the beam passes through lens 2005 whose object focal point is at the centre of galvanometric mirror 2003. It passes through lens 2006 whose object focal plane coincides with the image focal plane of 2005. It is reflected by galvanometric mirror 2007 whose centre is at the image focal point of lens 2006. Galvanometric mirror 2007 is mobile in rotation about an axis going through its centre and located in the plane of the figure. On this part of the light beam path, galvanometric mirrors 2003 and 2007 have the function of a beam deflector so the direction of the light beam in the observed object can be varied. The beam coming from mirror 2007 then passes through lens 2048 whose object focal point is at the centre of galvanometric mirror 2007. It then passes through lens 2049 whose object focal plane coincides with the image focal plane of lens 2048. It passes through lens 2008 whose object focal plane coincides with the image focal plane of lens 2049. It is reflected by mirror 2043 then by mirror 2009 and by the partially transparent mirror 2010. It then passes through condenser 2011. The image focal plane of lens 2008 is in the object focal plane of condenser 2011 so that on leaving the condenser the beam is parallel. The beam then passes through the observed object 2040 that diffracts it. After passing through the observed object, the light beam includes:

a non-diffracted part, made up of the part of the light beam that is parallel and in the same direction as before passing through the observed object,

a diffracted part, made up of the remainder of the light beam, that was diffracted by the observed object in a set of directions different from the direction of the beam before passing through the observed object.

The entire light beam, including a diffracted part and a non-diffracted part, then passes through objective 2012. The beam then passes through the tube lens 2044 whose object focal plane coincides with the image focal plane of the objective. It then passes through a lens 2045 whose object focal plane coincides with the image focal plane of lens 2044. The image focal plane of lens 2045 constitutes the second focal plane, and the second filtering device is placed in this plane. The second filtering device is made up of the optional mask 2046. The beam thus passes through optional mask 2046 placed in the image focal plane of lens 2045. It is reflected by mirror 2014 and passes through lens 2013 whose object focal plane is on the optional mask 2046. It is reflected by galvanometric mirror 2007 whose centre coincides with the object focal point of lens 2013. It is then reflected by mirror 2015 then passes through lens 2016 whose object focal point is at the centre of galvanometric mirror 2007. It passes through lens 2017 whose object focal plane coincides with the image focal plane of lens 2016. It is reflected by galvanometric mirror 2003 whose centre coincides with the object focal point of lens 2017. On this part of the path of the light beam, galvanometric mirrors 2003 and 2007 have a function of modifying the direction of the light beam coming from the observed object so as to compensate the variations of its direction. After reflection on mirrors 2003 and 2007, the non-diffracted part of the light beam has a fixed direction, independent of the direction of the light beam in the observed object. The beam coming from galvanometric mirror 2003 passes through lens 2018 whose object focal point is at the centre of galvanometric mirror 2003, that has the function of focusing, at a focal point of the first focal plane made up of the image focal plane of lens 2018, the part of the wave that was not diffracted by the observed object. It passes through the first filtering device placed in the first focal plane, and comprising the pierced half-wave plate 2019 and the optional filter plate 2047. The neutral axes of this half-wave plate are directed at 45 degrees from the plane of the figure so that the part of the beam that passed through the half-wave plate is polarized in the plane of the figure, with the part of the beam that passed through the hole pierced in this plate being polarized in the direction orthogonal to the plane of the figure. The beam then passes through an optional filter plate 2047 also forming part of the filtering device. The beam passes through lens 2020 whose object focal plane is on pierced half-wave plate 2019. It then reaches beam splitter 2021 that reflects one third of the light intensity. It then reaches beam splitter 2026 that reflects half the light intensity.

The part of the beam that was reflected by beam splitter 2021 then passes through the third-wave plate 2022 and polarizer 2023 then reaches CCD sensor 2024 connected to camera 2025 and situated in an image focal plane of lens 2020. A neutral axis of the third-wave plate 2022 is in the plane of the figure, such that this plate induces a phase shift of 120 degrees between the part of the beam that passed through the half-wave plate 2019 and the part of the beam that passed through the hole pierced in this plate. The polarizer is typically at 45 degrees to the plane of the figure. However different angles can be used.

Set 2027, 2028, 2029, 2030 is equivalent to set 2022, 2023, 2024, 2025 but the third-wave plate is turned by 90 degrees so as to generate a phase shift of −120 degrees.

Set 2031, 2032, 2033 is equivalent to set 2022, 2023, 2024, 2025 but the third-wave plate is removed.

The part of the beam that passes through partially transparent mirror 2010 reaches CCD sensor 2041 mounted on camera 2042 and placed in a frequency plane on which the non-diffracted part of the beam has a point image.

The condenser and objective are both achromatic/aplanatic. We note F_{obj} the focal length of the objective and F_{cond} the focal length of the condenser. We note F_{X} the focal length of lens number X. To ensure that deviations of the light beam and the beam having passed through the observed object by galvanometric mirrors are compensated exactly, the following equality must be respected:

$$\frac{{F}_{2008}}{{F}_{cond}} \frac{{F}_{2048}}{{F}_{2049}} = \frac{{F}_{2013}}{{F}_{2045}} \frac{{F}_{2044}}{{F}_{obj}}$$

Lens 2016 and lens 2006 are identical to each other, and lenses 2005 and 2017 are also identical to each other. The set-up's magnification comes to

$$g = \frac{{F}_{2020}}{{F}_{2018}} \frac{{F}_{2017}}{{F}_{2016}} \frac{{F}_{2013}}{{F}_{2045}} \frac{{F}_{2044}}{{F}_{obj}} .$$

For example, the following can be used:
a Nikon CF160 planachromatic objective with 1.25 numerical aperture forming the image at infinity and corrected independently of the tube lens, with focal length of 2 mm.
a Nikon planachromatic condenser, with focal length of 8 mm.
a lens 2008 comprising a Melles Griot optimized achromatic doublet, with focal length of 800 mm.
lenses 2044, 2045, 2013, 2016, 2017, 2006, 2005, 2018, 2020, 2048, 2049, 2008 all identical to the tube lens used on Nikon microscopes, with focal length of 200 mm.
a 2000 HeNe red laser with 633 mn wavelength.
lenses 2001 and 2002 optimized to constitute a beam expander, sized to obtain a beam approximately 10 mm in diameter.
a diaphragm 2043 about 8 mm in diameter.
CCD cameras with 512×512 useful square pixels (12-microns).
galvanometric mirrors with diameter of about 10 mm.

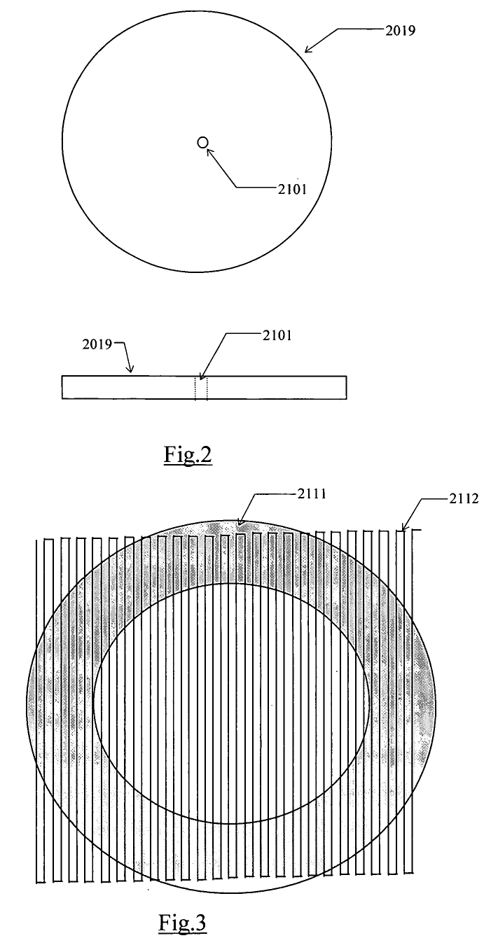

The pierced half-wave plate 2019 is shown in greater detail in FIG. 2. It comprises a half-wave plate pierced in its centre with a hole 2101 that may have been made using a power laser or mechanical means. Hole 2101 must be on the optical axis. Its diameter is greater than the diameter of the Airy disc formed by the beam on plate 2019, while being sufficiently weak. For example, in the specific sizing example given above, its diameter can be about 50 microns. Hole 2101 can be empty, though it is preferable for it to be filled with a material with an index close to that of the plate. For example, the plate can be pre-cut and pre-pierced, the hole can be filled using glass with the appropriate index, and the unit can be polished as a whole. Optical cement can also be used instead of glass. Filling the hole using a material with an index close to that of the plate means significant phase shift of the non-diffracted part of the wave can be avoided. This is particularly useful if a laser emitting several wavelengths simultaneously is used: in the presence of a significant phase shift, the images obtained for each wavelength would not then be superimposed constructively.

The system is designed such that the observed object is illuminated by a plane wave whose direction can be modified using galvanometric mirrors 2003 and 2007 that thus constitute a beam deflector so the direction of the light beam in the observed object can be varied. Furthermore, the system is also designed so that in the absence of an observed object, the focal point of the non-diffracted part of the light beam on the pierced half-wave plate 2019 is a fixed point, located on the optical axis, and coinciding with hole 2101 pierced in this plate. In the presence of an observed object, only the part of the light beam that was not diffracted by the observed object passes through this fixed point. The hole pierced in the plate constitutes a central point of the filtering device so that polarization of the part of the wave that passes through this point (the non-diffracted part of the light beam) and polarization of the part of the wave that passes through other points (the diffracted part of the light beam) can be modified differently. Galvanometric mirrors 2003 and 2007 constitute both:
a beam deflector to modify the direction of the light beam illuminating the observed object,
a set of mobile mirrors to modify the direction of the light beam once it has passed through the observed object, so that the direction of the non-diffracted part of the beam, after reflection on these mirrors, is independent of its direction in the observed object.

This allows the focal point of the non-diffracted part of the light beam, in the first focal plane where plate 2019 is placed, to be fixed. In the present case, these two functions of the galvanometric mirrors are assumed by opposite faces of these mirrors.

Setting of the assembly has to be implemented to ensure that in the absence of the observed object, the wave does pass through a fixed point of plate 2019. This primarily involves adjusting the focal length of a lens, for example lens 2013, so that the position of the point of impact of the wave on 2019 remains independent of the position of the galvanometric mirrors (in so far as the wave actually passes through the condenser and the objective). To this purpose, for example, a doublet of adjacent achromatic lenses can be used as lens 2013, with the distance between these lenses being adjustable. The focal length of the doublet is then modified by adjusting the distance between its two simple lenses. For the adjustment, 2019 can be replaced by a CCD sensor so as to be able to measure displacements from the point of impact on this sensor when the orientation of the galvanometric mirrors varies. For suitable setting of the focal length of 2013, this point of impact is fixed.

Once this setting has been made, pierced plate 2019 can be installed so that hole 2101 coincides with the point of impact of the beam in the absence of the observed object. To set the position of the pierced plate, a mirror and a lens can be placed temporarily to form the image of the plate on an auxiliary CCD, together with a polarizer set in rotation to strongly attenuate the part of the wave that is polarized in the plane of FIG. 1. When the hole coincides with the point of impact of the beam, the intensity reaching the auxiliary CCD will be at its maximum. For this setting, plate 2019 must be assembled on a 3-axis positioner.

Once this setting has been performed, it is necessary to set the position of the CCD sensors. To do so, an absorbing mask including holes can be placed in the spatial plane located between lenses 2044 and 2045. Images of this mask acquired using the three CCDs can then be superimposed on a computer screen and the position of the CCDs can be set to bring these images to coincide and ensure they are clearly defined. CCD sensors have to be mounted on the 3-axis positioners to implement this setting.

The three cameras must be synchronized with each other and with the galvanometric mirrors so that their integration times coincide and also correspond to the time during which the illuminating wave scans the object focal plane of the condenser.

A complex elementary image is generated from the real images detected on the three CCD cameras by carrying out the following calculation:

$$T [ i , j ] = \frac{1}{6} ( 2 {I}_{2032} [ i , j ] - {I}_{2024} [ i , j ] - {I}_{2029} [ i , j ] ) + \frac{j}{2 \sqrt{3}} ( {I}_{2024} [ i , j ] - {I}_{2029} [ i , j ] )$$

where Iₓ [i, j] represents the intensity detected at coordinate point ij of CCD number X.

A reference image can be obtained by inserting, in the spatial plane located between lenses 2044 and 2045, a plate provided over a reduced area with a slight extra thickness, causing a phase shift equal for example to π/16. This plate can typically be a phase plate of the type used in phase contrast, but generating a weaker phase shift. This plate's image is formed on the sensors and the corresponding complex image T_{ref} [i,j] can be obtained. The ratio

$$M = \frac{{T}_{ref} [ {i}_{1} , {j}_{1} ]}{{T}_{ref} [ {i}_{0} , {j}_{0} ]}$$

where (i₁,j₁) are the coordinates in pixels of the image of a point with extra thickness, and (i₀, j₀) are the coordinates of the image of a point with no extra thickness is calculated. This ratio makes it possible to normalize the image. The normalized elementary image

$$C [ i , j ] = \frac{T [ i , j ]}{\tilde{j} M}$$

where j designates the complex root of the unit is then used. The normalized elementary image of a slightly diffracting point is real if this point is uniquely absorbent and complex if this point is not absorbent and has an index different from that of the medium it is in.

These formulae are similar to those used in patent WO99/53355 or in proceedings of SPIE vol.4164 p.122-133. The non-diffracted part of the wave, that passes through hole 2101, is used as a reference wave and has phase shifts in relation to the diffracted part of the wave applied to it, using third-wave plates. The polarizers can be directed at 45 degrees from the plane of FIG. 1, but through modifying their orientation the relative intensity of the reference wave and the diffracted wave can be modified. The three polarizers must, however, be oriented in the same manner, so that the reference wave has the same amplitude on the three corresponding sensors.

This microscope can be used in several ways:

Method 1) Generation of sections of the observed object. In this imaging mode, mask 2046 and filter plate 2047 are not used. To generate sections of the observed object, galvanometric mirrors are controlled so that the point of impact of the illuminating wave in the object focal plane of the condenser moves such that the light intensity received at a point of the focal plane during the camera integration time is independent of the position of this point within the limits defined by the aperture diaphragm. For example, the point of impact of the illuminating wave in the object focal plane of the condenser may cover a path of the type shown in FIG. 3, the rate of movement of the point being roughly constant in the rectilinear parts of this path, and the entire path being covered during the camera integration time. In FIG. 3 are shown the aperture diaphragm 2111 of the condenser and the path 2112 of the point of impact of the illuminating wave. Such a path can typically be obtained using a resonant galvanometric mirror and a second slower galvanometric mirror, according to a method commonly used in confocal microscopy. The complex image V[i,j] obtained from real images detected on the three sensors is a section of the observed object. However, this section is imperfect and can be improved by taking several successive sections, with the position of the observed object along the optical axis being incremented by a constant value between each section. These sections are indexed with an index k. A complex three-dimensional table H[i,j, k] is thus obtained in which each element of the table corresponds to a point of the observed object, with H[i, j, k]=Cₖ[i, j] where Cₖ[i, j] is the normalized elementary image obtained for the position characterized by the index k. This table can be improved by a deconvolution to compensate the point spread function or pulse response of the system. The deconvolution filter can be obtained by theoretical considerations or measurement using a point object, for example a bead of the type used to gauge confocal microscopes. The path of the point of impact of the wave in the focal plane of the condenser can be checked using CCD sensor 2041. The real part of the image obtained corresponds, for slightly diffracting objects, to absorptivity. The imaginary part corresponds, for slightly diffracting objects, to the index of refraction. The deconvolution filter is the same as that used for example in the article “Reconstructing 3D light-microscopic images by digital image processing”, by A. Erhardt et al, applied optics vol.24 No 2, 1985.

Method 2) Use in tomographic mode.

In this imaging mode, mask 2046 and optional filter plate 2047 are not used. Use in tomographic mode involves applying a method of the type described in patent WO99/53355 and in proceedings of SPIE vol.4164 p.122-133. However, here there is no random phase shift to compensate for. Moreover, the parts of frequency representation whose superposition generates frequency representation of the observed object are obtained in a slightly different manner.

The Fourier transform

$$\tilde{C} [ p , q ] = {\sum }_{i , j}^{} C [ i , j ] {ⅇ}^{j2π ( \frac{ⅈ p + j q}{{N}_{pix}} )}$$

of the normalized elementary image C[i, j] obtained for a given position of the galvanometric mirrors is used. Nₚᵢₓ×Nₚᵢₓ is the dimension of the useful area of the CCD sensor, and the indices vary from

$$- \frac{{N}_{pix}}{2} to \frac{{N}_{pix}}{2} - 1.$$

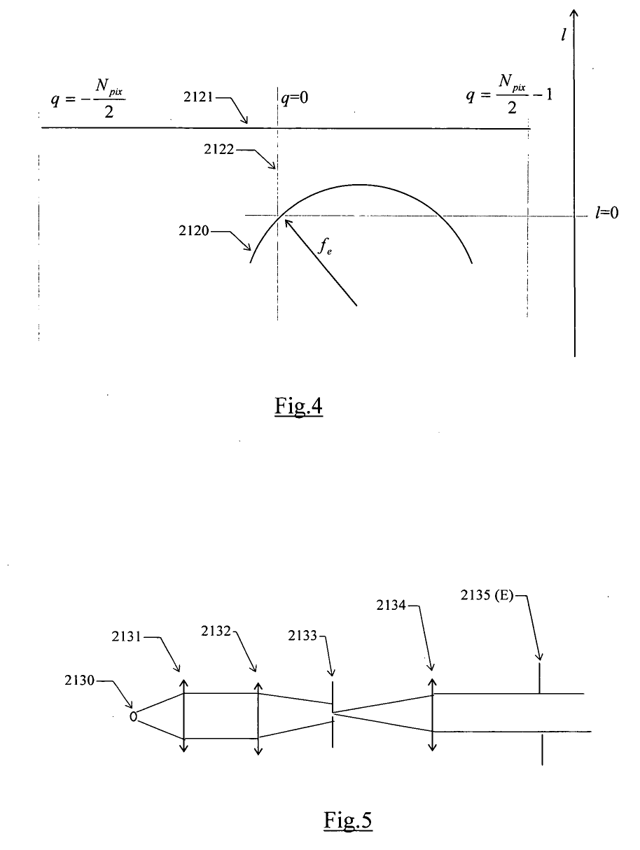

\tilde{C}[p,q] is the projection on a horizontal plane along the index L determining the vertical direction of a spherical part of the three-dimensional frequency representation of the observed object F[p,q,l] . FIG. 4 shows as a vertical section along q,l the spherical part 2120 of the representation F[p,q,l], as well as the wave vector fₑ of the illuminating wave reduced to the scale of this representation, and the 2D support 2121 of \tilde{C}[p,q]. The image detected on CCD 2041 gives the wave vector fₑ and thus means the position of the portion of sphere 2120 can be determined. \tilde{C}[p,q] can then be projected on this portion of sphere along the vertical direction 2122 to obtain a portion of the frequency representation of the observed object. The three-dimensional representation F[p,q,l] can then be obtained as in patent WO99/53355 and proceedings of SPIE vol.4164 p. 122-133 by superposition of a set of such portions of spheres obtained for a series of illuminating waves with different directions and obtained by displacing the galvanometric mirrors. The spatial representation is obtained by inversion of the Fourier transform.

Method 3) Obtaining projections of an object.

Projections of an observed object can be obtained using the second filtering device comprising opaque mask 2046 of the type shown in FIG. 7 including an aperture 2161 in the form of an elliptic band placed in a second focal plane, in which the non-diffracted part of the light beam from the observed object is focused.

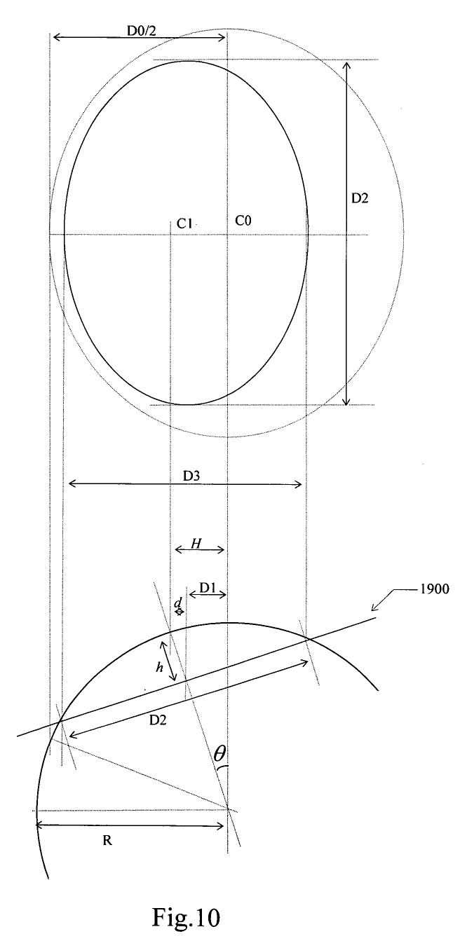

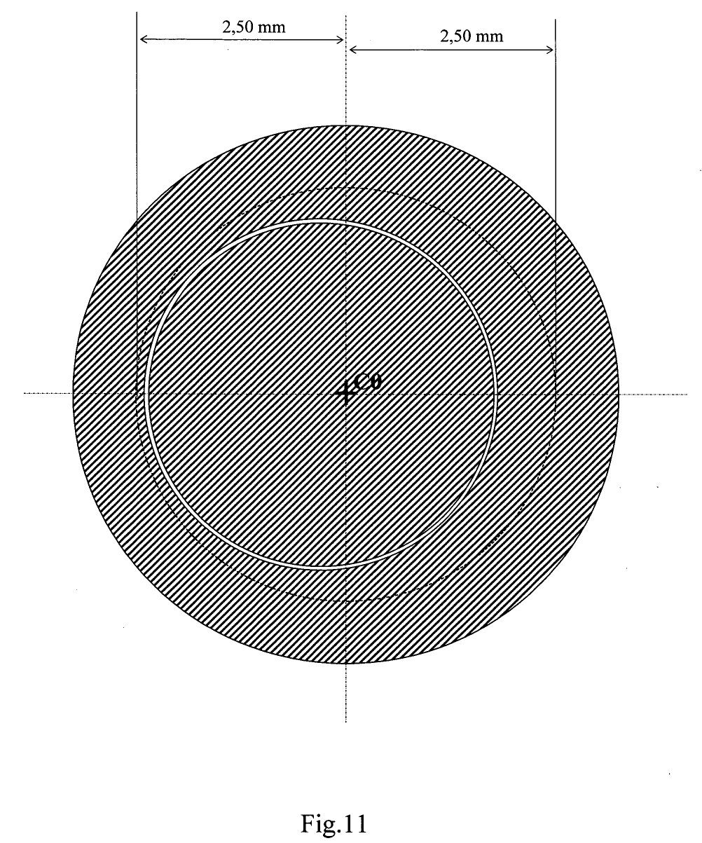

FIG. 10 explains the elements for calculation of this elliptic band and provides detail on the method to obtain the characteristics of an ellipse limiting the elliptic band 2161. In this figure, parameter R is expressed

$$R = n {F}_{obj} \frac{{F}_{2045}}{{F}_{2044}}$$

where n is the index of the optical oil for which the objective is designed. The diameter D0 of circle 2160 limits the useful part of the plane, considering the aperture of the objective. This can be expressed D0=2ouv.

$${F}_{obj} \frac{{F}_{2045}}{{F}_{2044}} .$$

The angle between the direction of projection and the optical axis is θ. The other parameters can be deduced from the figure:

The ratio of the minor axis to the major axis is

$$\frac{D 3}{D 2} = cos ( θ ) .$$

The position of the centre of the ellipse C1 in relation to the optical centre C0 is obtained by:
D1=H−d
H=R sin θ
d=h sin θ

$$\frac{D 2}{2} = \sqrt{{R}^{2} - {( R - h )}^{2}}$$

whence finally:

$$D 1 = \frac{n}{2 ouv} D 0 sin θ \sqrt{1 - {( \frac{D 2}{D 0} \frac{ouv}{n} )}^{2}}$$

For example, in the particular sizing example given above, D0=5 mm and an ellipse limiting a usable mask for θ=8 degrees has, for example, the following characteristics, obtained from the previously indicated equations:

| parameter | value |
|---|---|
| D1 | 0.30 |
| D2 | 4.25 |
| D3 | 4.21 |

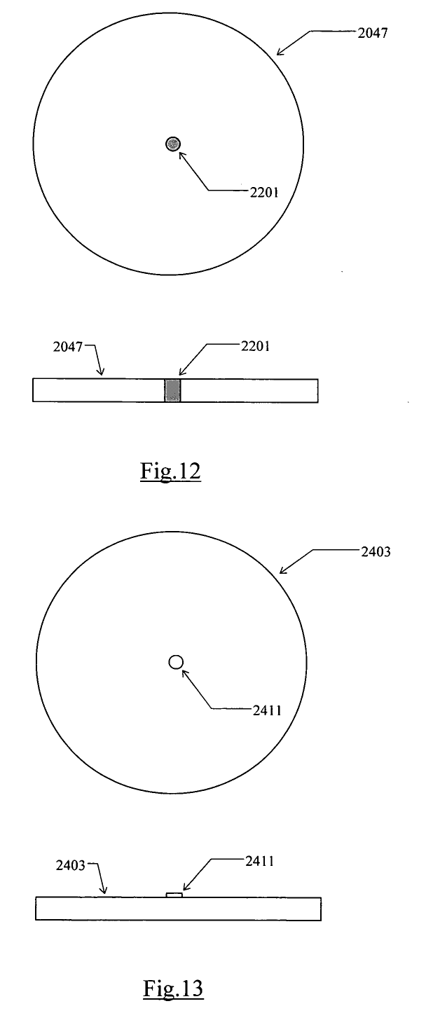

The width of the elliptic band must be greater than the diameter of the Airy disc formed in the second focal plane where mask 2046 is located. In the present case, it may, for example, equal 20 microns. This elliptic band mask is shown in FIG. 11 for an elliptic band width equal to 20 microns. The greater the band width, the lesser will be the depth of field of the obtained image and the greater the luminosity. It is thus preferable to use a low band width in so far as this band width remains compatible with the required luminosity.

If a projection along the optical axis is required, the band is annular and centred on the optical axis. If a more inclined projection direction is sought, ellipticity will become more pronounced and the band will be more off-centre relative to the optical axis.

It is also possible to place the elliptic band mask in another focal plane, for example a plane where the phase plate is usually placed in a phase contrast objective.

The galvanometric mirrors must then be controlled so that the point of impact of the light beam on this mask scans the elliptic band during the sensor integration time. The image C[i, j] obtained is then a projection along the vertical direction. This image can be improved by a two-dimensional deconvolution whose characteristics can be obtained either by measurement of the pulse response or by theoretical considerations.

In this imaging mode, the main part of the diffracted wave is stopped by mask 2046. However, the non-diffracted part of the wave completely passes through the mask. If no particular precautions are taken, the diffracted wave becomes negligible compared to the non-diffracted wave and therefore becomes difficult to detect. To remedy this defect, a filter plate 2047 has to be used. This plate is shown in FIG. 12. It may, for example, comprise a transparent window also including an absorbent element 2201 that can, for example, be made of tinted glass or plastic and with a diameter, in the particular example of sizing given above, of approximately 50 microns. This absorbent element 2201 must be placed just above the “hole” made in pierced plate 2019. The window 2047 can also be removed and a plastic absorbent element poured directly into hole 2101 made in the pierced plate. The absorbent element has the role of attenuating the non-diffracted wave to facilitate detection of the diffracted wave. Filter plate 2047 can also be used to perform more elaborate filtering of the image and can, for example, have absorptivity that diminishes moving out from its centre 2201 to the edges, thus allowing improved resolution.

Using beam splitters and fast switches, for example based on ferroelectric liquid crystals, two paths can also be separated, on which two different masks can be used. Using these two paths alternately, two projections forming a stereoscopic image are generated. The mask can also be made of a spatial modulator with liquid crystals so modification of the direction of observation can be made as required.

Different methods as compromises between section generation, projection, and tomographic modes can be used. In general, the tomographic mode is the one that allows for best quality of image, while the two other modes are used for real time observation.

Variations of this embodiment can be used. In particular, several lasers with different wavelengths can be used, with a switching system between these lasers or a system superposing the lasers to obtain a colour effect.

It is also possible to use a light source as described by FIG. 5. In this figure, light is produced on the focus 2130 of a high intensity lamp, for example a mercury vapour lamp. This flight is collected by a collector 2131 then focused by a lens 2132 towards a hole 2133. If this hole is small enough, it provides a point source. The light from this microscopic hole passes through a lens 2134 then field diaphragm 2135. The object focal plane of lens 2134 is on the microscopic hole 2133. The image focal plane of lens 2134 is on diaphragm 2135. The light from field diaphragm 2135 can replace the light from the laser and from its beam expander. The main advantage of this source of light is that it is inexpensive and polychromatic, meaning a monochromator filter can be used to select various wavelengths. However, even if this system is successfully optimized, most of the light coming from the source is lost and the useful intensity is thus somewhat reduced. This problem can be solved by simultaneously widening the microscopic hole 2133 and hole 2101 made in plate 2019. However, this introduces approximations that can reduce the quality of the image. Indeed, if the area illuminated in the object focal plane of the condenser is too large:
the width of microscopic hole 2101 must be sufficient to cover the image of this area in the plane of plate 2019. The diffracted part of the wave also passing through this area a considerable part of this diffracted wave will be modified in the same way as the non-diffracted wave.
the width of the ellipse applied in the “obtaining projections of an object” (wide depth of field) mode must remain higher than the width of the image of the area illuminated in the plane of mask 2046. This limits the depth of field that can be obtained.
similarly, in “tomographic” mode, the extension along the vertical axis of the three-dimensional image that can be obtained is limited.

If such a source is used, a sufficiently sensitive camera must be used. Moreover, the half-wave and third-wave plates must be achromatic, which is also the case when several lasers are used.

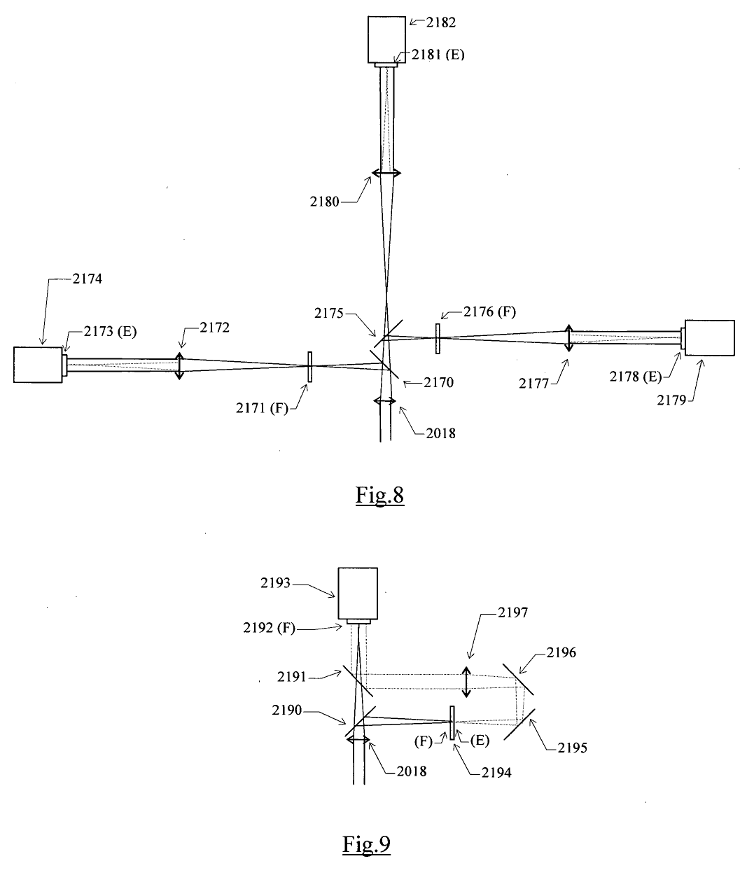

It is not essential to use wave plates to generate phase shifts. FIG. 8 shows a detection device that can replace the one in FIG. 1. Having passed through lens 2018 the wave is divided into three by beam splitters 2170 and 2175. The part of the wave that is reflected by 2170 then passes through a plate 2171 placed in a frequency plane and provided with extra thickness at the point of impact of the non-diffracted part of the illuminating wave. The extra thickness must be such as to generate a phase shift of 120 degrees between the wave passing through it and the wave that does not pass through it. The wave then passes through lens 2172 whose object focal plane is on plate 2171 and reaches CCD 2173 located in the image focal plane of 2171 and secured to the camera 2174. The set 2176, 2177, 2178, 2179 is equivalent to set 2171, 2172, 2173, 2174 but the extra thickness generates a phase shift of 240 degrees. The set 2180, 2182, 2183 is also equivalent but does not include a plate with extra thickness (it may possibly include a plate without extra thickness).

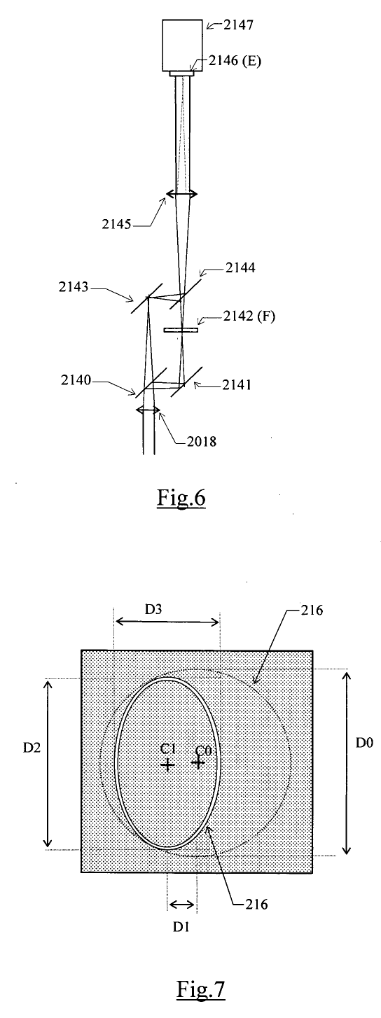

It is also possible to use a single camera. In this case, the images corresponding to the three phase shifts must be taken in succession. The three cameras can for example be replaced by the device in FIG. 6. In this figure, once it has passed through the part of the device of FIG. 1 that is in front of this lens, the beam coming from lens 2018 reaches a beam splitter 2140. The part of the beam that is reflected by 2140 is then reflected by piezoelectric mirror 2141 and reaches the microscopic hole 2142 that coincides with the point of impact of the wave in the absence of an observed object. The part of the wave that passes through this microscopic hole mainly includes the non-diffracted part of the wave and will be used as a reference wave. It thenpasses through beam splitter 2144.

The part of the wave that passes through beam splitter 2140 is reflected by mirror 2143 and by semi-transparent mirror 2144. The two superimposed waves then pass through lens 2145 and reach CCD sensor 2146 integrated in camera 2147.

The orientation of mirror 2143 must be set to obtain uniform lighting on the camera in the absence of an observed object.

The operating mode is similar to the previous one but simultaneous acquisition on the three cameras is replaced by successive acquisition of images corresponding to phase shifts of 0, 120 and 240 degrees. The phase shifts are implemented using piezoelectric mirror 2141. During the three successive acquisitions needed to obtain a complex image, the galvanometric mirrors must be controlled in exactly the same way.

It is possible to add a plate bearing an absorbent point at the point of impact of the non-diffracted part of the wave in the focal plane located between 2140 and 2143 to only retain the diffracted wave on this path.

The cameras are not necessarily in an image plane. FIG. 9 shows a detection system with a camera placed in a frequency plane. Having passed through lens 2018 the wave passes through beam splitters 2190 and 2191 before reaching CCD 2192 located in a frequency plane for this wave. The part of the wave that is reflected by beam splitter 2190 passes through the microscopic hole 2194 that coincides with the fixed point of impact of the non-diffracted part of the wave. The part of the wave that passed through 2194 constitutes the reference wave and the microscopic hole 2194 can be regarded as being in a spatial plane for this wave. The wave coming from 2194 is reflected on piezoelectric mirror 2195 and mirror 2196. It passes through lens 2197, is reflected by beam splitter 2191 and reaches CCD 2192 secured to camera 2193. The operating procedure is similar to that for the device described in FIG. 6, with phase shifts now being implemented using piezoelectric mirror 2195. But the complex value obtained with the pixel for coordinates i,j now represents C[i, j] instead of C[i, j] and an inverse Fourier transform must thus be performed to find the image of the observed object. Detection systems using three cameras in frequency planes and a separation of the wave front by polarization can also be designed. It is possible to add an intermediate frequency plane in front of the camera in which a plate bearing an absorbent point located at the point of direct impact of the non-diffracted wave is placed. This means saturation of the camera at this point can be avoided.

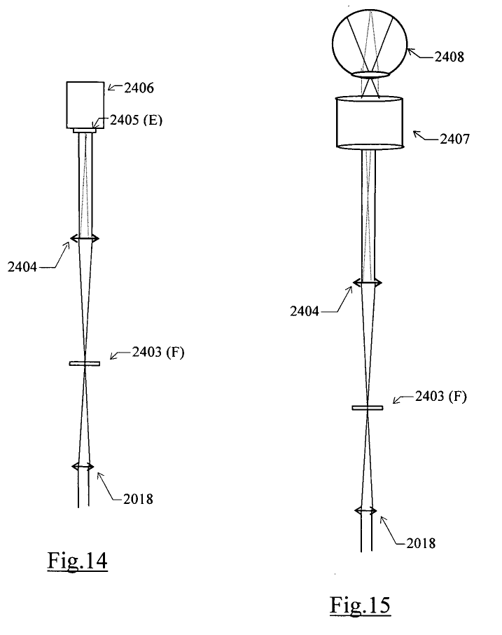

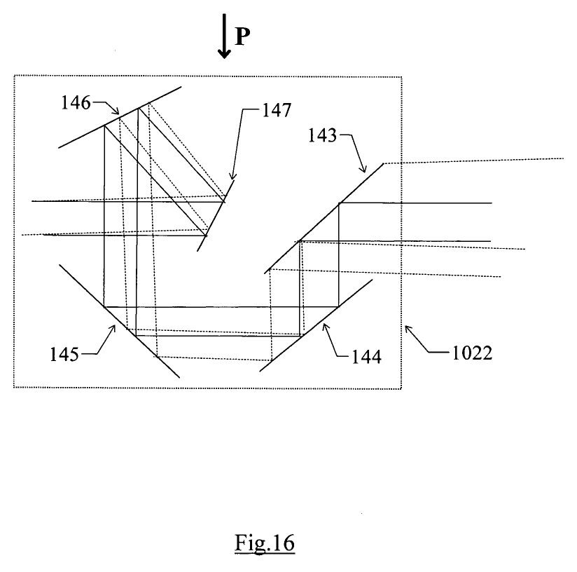

It is also possible to remove the cameras and observe the image directly using an eyepiece, or use just one camera but on which a single image is acquired and retransmitted to a computer screen without preliminary processing. In this case the part of the system in FIG. 1 located after lens 2018 is replaced by that shown in FIG. 14. The wave from 2018 passes through a plate 2403 located in the image focal plane of lens 2018, then passes through lens 2404 whose object focal plane is on plate 2403 and reaches CCD sensor 2405 secured to camera 2406. The sensor and the camera can be replaced by an eyepiece 2407 forming the image on the retina of the eye 2408 as indicated in FIG. 15. Plate 2403 is shown in FIG. 13 for the case in which a phase contrast image is required. This comprises a window with an extra thickness 2411 in its centre generating, for example, a phase shift of π2. The extra thickness 2411 must be placed at the fixed point of impact of the non-diffracted part of the illuminating wave. For a bright field image, plate 2403 is not essential, while for an image in “obtaining projections” mode plate 2047 must also be used.

The diagrams in FIGS. 1,6,8,9,14 and 15 can usefully be supplemented by possibly adjustable, neutral filters so the light intensity in the various parts of the device can be adjusted.

### Second Embodiment (Preferred Embodiment)

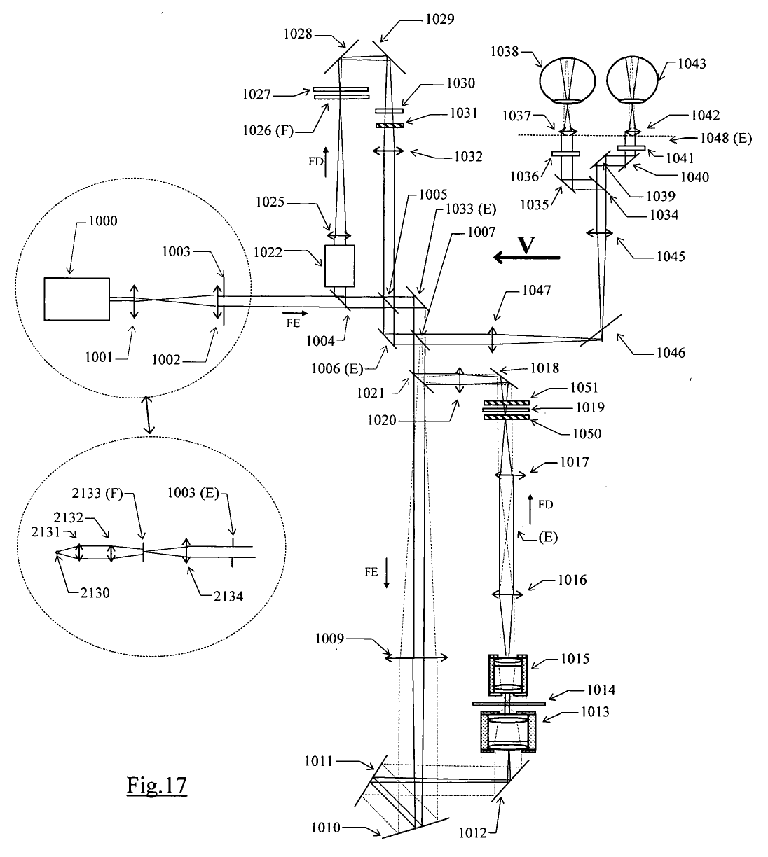

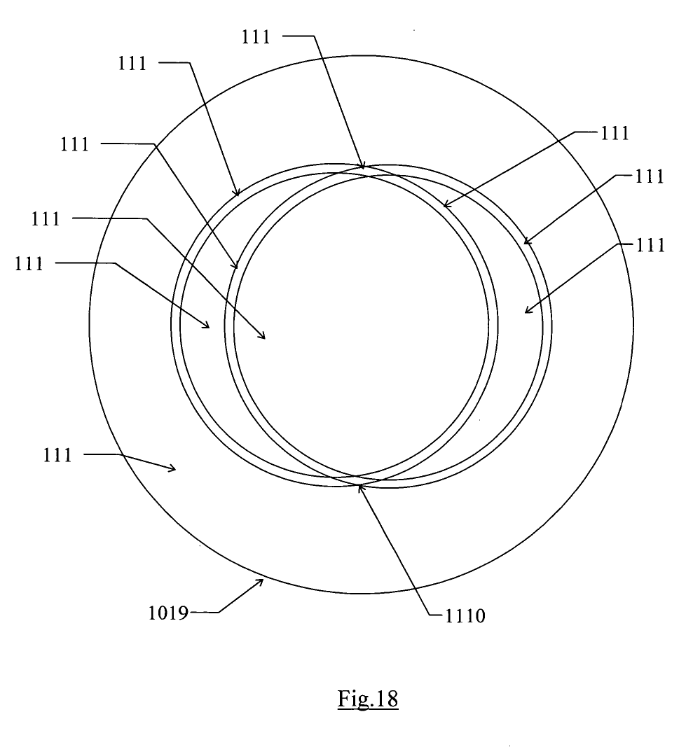

A second embodiment is shown in FIG. 17. It differs from the first embodiment due to the wave having passed through the first filtering device then being redirected by galvanometric mirrors. This solution is advantageous in that:
it is not essential to place the galvanometric mirrors exactly in spatial planes,
the system is less sensitive to long-term drifts in position of these mirrors,
the non-diffracted part of the light beam has a variable direction coming out of the system allowing for direct observation without the danger related to the use of coherent light,
the speckle effect, due to parasitic reflection in the part of the system where the beam has a constant direction, is reduced.

The linearly polarized beam from laser 1000 passes through the beam expander made up of lenses 1001 and 1002, then passes through diaphragm 1003. It passes through the polarizing beam splitter 1004, it is reflected by galvanometric mirror 1005, by mirror 1006 and by galvanometric mirror 1007. Galvanometric mirrors 1005 and 1006 constitute a beam deflector (second set of mobile mirrors) so the direction of the light beam in the observed object can be varied. The beam then passes through polarizing beam splitter 1021, then through lens 1009. It is reflected by mirrors 1010 and 1011, then by mirror 1012. It passes through the condenser 1013, the observed object 1014, the objective 1015, the tube lens 1016 and the lens 1017. It passes through polarizer 1050 that selects only the main polarization direction (polarization direction of the non-diffracted part of the wave) to obtain a perfectly linearly polarized beam. It passes through the second filtering device, comprising the polarization rotator 1019 whose electrodes are shown in FIG. 18 and that allows either the entire beam or the beam passing through the frequency plane on one or more elliptic bands to pass through. It then passes through polarizer 1051 oriented orthogonally to polarizer 1050. It is reflected by mirror 1018 and passes through lens 1020. It is then reflected by the polarizing beam splitter 1021. It is then reflected by galvanometric mirror 1007, mirror 1006 and galvanometric mirror 1005. Galvanometric mirrors 1006 and 1005 constitute, on this part of the beam path, a first set of mobile mirrors such that after reflection on these mirrors, the direction of the beam is independent of its direction in the observed object. The beam is then reflected by polarizing beam splitter 1004. It is successively reflected by mirrors 143, 144, 145, 146 and 147 making up assembly 1022 represented by a block in FIG. 17, that are shown in FIG. 16 in a view along direction V shown in FIG. 1. Unit 1022 is used to reverse the beam angle relative to a plane containing the optical axis and located in the plane of FIG. 1. The direction P shown in FIG. 16 shows the direction of observation from which FIG. 17 is produced. The beam passes through lens 1025, whose role is to focus the non-diffracted part of the light beam on the first focal plane. The pierced plate 1026 and filter plate 1027 provide the first filtering device, placed in the first focal plane. Once the beam has passed through this first filtering device, it is reflected by mirrors 1028 and 1029, passes through retardation plate 1030, directional polarizer 1031 and lens 1032. It is reflected by the second face of galvanometric mirror 1005, by mirror 1033 and by the second face of galvanometric mirror 1007. In this part of the light beam's path, galvanometric mirrors 1005 and 1006 constitute a third set of mobile mirrors with the following functions:
varying the direction of the non-diffracted part of the light beam to make it directly observable to the eye without the danger inherent in observation of a fixed focused laser beam.
compensating for the displacement of the image plane caused by previous reflection on the galvanometric mirrors making up the first set of mobile mirrors, that are not both in an image plane as in the first embodiment.

The light beam then passes through lens 1047, is reflected by mirror 1046 and passes through lens 1045. It is then split in two by the semi-transparent mirror 1034. Part of the beam is reflected by mirrors 1039 and 1040 and passes through shutter 1041 comprising a liquid crystal polarization rotator and a polarizer. This part of the beam passes through the eyepiece 1042 and reaches the eye 1043. The other part of the beam is reflected by mirror 1035, passes through shutter 1036 and eyepiece 1037 before reaching the eye 1038.

Laser 1000 can be a laser emitting several wavelengths simultaneously, or a combination of several lasers whose outputs are superimposed by dichroic mirrors, so as to obtain a colour image.

The object focal plane of lens 1009 is on mirror 1006. The image focal plane of lens 1009 coincides with the object focal plane of condenser 1013. The object focal plane of lens 1016 coincides with the image focal plane of objective 1015. The image focal plane of lens 1016 coincides with the object focal plane of lens 1017. The polarization rotator 1019 is in the image focal plane of lens 1017 and in the object focal plane of lens 1020. The image focal plane of lens 1020 coincides with the object focal plane of lens 1009. The object focal plane of lens 1025 coincides with the image focal plane of lens 1020. The pierced half-wave plate 1026 is in the image focal plane of lens 1025. The object focal plane of lens 1032 coincides with the image focal plane of lens 1025. The distance between 1033 and 1005 is $$$ equal to the distance between 1006 and 1005. The image focal plane of lens 1032 is on mirror 1033. The object focal plane of lens 1047 is on mirror 1033. The image focal plane of lens 1047 coincides with the object focal plane of lens 1045. The image focal plane of lens 1045 is the image plane 1048 observed using eyepieces 1042 and 1037.

As previously, we note F_{N} the focal length of lens number N, ouv the aperture of the objective and the condenser, F_{cond} the focal length of the condenser and F_{obj} the focal length of the objective. For the deflections of the beam on the various parts of its path to compensate each other effectively, the following relations must be verified:

$$\frac{{F}_{cond}}{{F}_{1009}} \frac{{F}_{1016}}{{F}_{obj}} \frac{{F}_{1020}}{{F}_{1017}} = 1$$

$${F}_{1032} = {F}_{1025} .$$

The electrodes of the polarization rotator 1019 are shown in FIG. 18. They form two almost annular elliptic bands, each being of the type shown in FIG. 11. These two bands are made up of electrodes 1111 to 1115. The remainder of the surface of the rotator is made up of electrodes 1116 to 1119 that are all connected to the same electric potential.

To obtain a cross-sectional image, the galvanometric mirrors are controlled so that the point of impact of the non-diffracted part of the illuminating wave scans the part of the polarization rotator 1019 that is accessible taking into account the objective aperture, or in equivalent fashion so that the point of impact of the illuminating wave scans the entire object focal plane of condenser 1013. All electrodes of the rotator are then controlled so that the light can pass through polarizer 1051. Switches 1041 and 1036 are open.

To obtain a stereoscopic image, the electrodes of the polarization rotator 1019, galvanometric mirrors 1007 and 1005 and shutters 1041 and 1036, must be controlled synchronously. The formation of a stereoscopic image comprises a left image formation phase and a right image formation phase. These two phases alternate quickly enough for the eye to be unable to distinguish them.

During the left image formation phase:
shutter 1041 is open.
shutter 1036 is closed.
electrodes 1110, 1111, 1112, 1113, are controlled so that the light passing through them has its polarization changed and passes through polarizer 1051.
the other electrodes of the polarization rotator 1019 are controlled so as to preserve the polarization of the light passing through them so that this light is stopped by polarizer 1051.
galvanometric mirrors 1005,1007 are controlled so that the point of impact of the illuminating wave has an elliptic path, scanning the ellipse formed by electrodes 1110, 1111, 1112, 1113.

During the right image formation phase:
shutter 1041 is closed.
shutter 1036 is open.

electrodes 1110, 1111, 1114, 1115, are controlled so that the light passing through them has its polarization changed and passes through polarizer 1051.
the other electrodes of the polarization rotator 1019 are controlled so as not to change polarization of the light passing through them so that this light is stopped by polarizer 1051.
galvanometric mirrors 1005,1007 are controlled so that the point of impact of the illuminating wave has an elliptic path, scanning the ellipse formed by electrodes 1110, 1111, 1114, 1115.

Polarizer 1051 is not absolutely essential in so far as the polarizing beam splitter 1021 is sufficient to select suitable polarization.

The pierced half-wave plate 1026 is of the same type as pierced half-wave plate 2019 in the previous embodiment. Filter plate 1027 is of the same type as filter plate 2047. The retardation plate 1030 can possibly be replaced by an assembly with variable phase shift of the type described in:

P.Hariharan, “Achromatic phase shifting for polarization interferometry”, Journal of modern optics vol. 43 No 6 pp.1305-1306, 1996.

By turning the polarizer 1031 and the mobile wave plate of the variable phase shift assembly replacing the retardation plate 1030, continuous switching from the conventional bright field to the strongly contrasted bright field and phase contrast can be obtained. By replacing filter plate 1027, the type of filtering applied can also be changed and a dark field image obtained.

A simplified system can be obtained by removing plate 1026, plate 1030 and polarizer 1031. In this case, the modifications to the non-diffracted part of the light beam are obtained solely by means of the filter plate 1027 and can only be modified by replacing this plate. This plate then alone constitutes the first spatial filtering device. By modifying the absorbance of the central point of this plate, the contrast of the image obtained can be modified. By modifying its thickness, and thus the phase shift it applies to the light beam, a phase contrast image can be obtained.

To compensate for the relative slowness of galvanometric mirrors, the system can be completed with an acousto-optical deflector placed, for example, between laser 1000 and lens 1001. This deflector can be used to deflect the beam rapidly. Changing the beam direction in the observed object will then be partly due to the galvanometric mirrors and partly to the acoustic-optical deflector. Deflection due to the acoustic-optical deflector must remain much lower in amplitude to that due to the galvanometric mirrors, so that the point of impact of the non-diffracted part of the wave on the pierced half-wave plate moves in a small area around its mean position. Then it is sufficient to slightly enlarge the hole of the pierced plate for the non-diffracted part of the wave to pass through it whatever the state of the acoustic-optical deflector. If the acoustic-optical deflector deflects the beam in one direction only, the hole of the pierced plate can be given an elongated form.

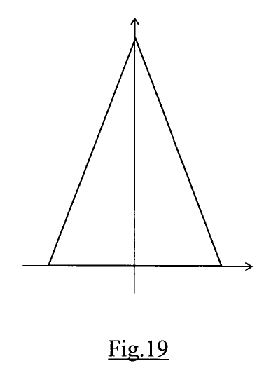

When the electrodes of the polarization rotator 1019 all let light through and in the absence of filter plate 1027, the frequency response of the microscope (Fourier transform of the pulse response or “point spread function”, for a point of the observed object located in the focal plane), takes the form shown in FIG. 19, where the two-dimensional spatial frequency modulus is represented on the X-axis, and where the amplitude of the frequency representation is on the Y-axis. This frequency response is the same as for a conventional microscope in bright field. The amplitude decreases for high spatial frequencies, which results in a reduction in resolution as perceived by the observer. This resolution can be improved by correcting the frequency response using an appropriate filter plate 1027, with the corrected system frequency response then being roughly constant until the maximum spatial frequency is reached.

The frequency representation in FIG. 19 brought back to the Fourier plane in which filter plate 1027 is to be found is proportional to |rₘₐₓ-r|

$$with {r}_{max} = ouv \cdot {F}_{obj} \frac{{F}_{1017}}{{F}_{1016}} \frac{{F}_{1025}}{{F}_{1020}} ,$$

and where r is the distance to the optical axis. To compensate for this response, a filter plate can be used with transmissivity T(r) depending on the distance r to the optical axis and equal to:

$$\text{-} if r \leq {r}_{lim} \text{:} T ( r ) = {\vert \frac{{r}_{max} - {r}_{lim}}{{r}_{max} - r} \vert}^{2}$$

$$\text{-} if r \geq {r}_{lim} \text{:} T ( r ) = 1$$

where rₗᵢₘ is a boundary value ranging between 0 and rₘₐₓ. According to the Rayleigh criterion, the effective resolution obtained then roughly equals:

$$1 , 21 \cdot \frac{λ}{4 ouv} \frac{2 {r}_{max}}{{r}_{lim} + {r}_{max}}$$

For example, rₗᵢₘ=0,75rₘₐₓ can be used and a resolution limit of 0.57 times the resolution limit usually obtained with a bright field microscope (Rayleigh limit) obtains. In this case the minimal value reached by T(r) is T(0)=0,0625.

If only an increase in bright field resolution is sought, the pierced plate 1026, wave plate 1030 and polarizer 1031 can be removed. The first filtering device will then comprise only plate 1027.

This method to increase resolution can also be used in other embodiments.

As indicated in FIG. 17, an inexpensive system can be obtained by replacing the laser and beam expander with the system shown in FIG. 5 and already described in the first embodiment. The wave from the emissive area 2130 of an arc lamp passes through the collecting lens 2130 and is then refocused by a lens 2132 onto a hole 2133 located in a frequency plane. This hole is placed in the object focal plane of lens 2134, with the field diaphragm 1003 being placed in the image focal plane of this lens. For luminosity to be at maximum level while remaining compatible with the resolution enhancement method described here, the diameter of hole 2133 in FIG. 5 can for example be as follows:

$${D}_{2133} = ouv \cdot {F}_{cond} \frac{{F}_{2134}}{{F}_{1009}} \frac{{r}_{lim} - {r}_{max}}{{r}_{max}}$$

To compensate for loss of luminosity that, compared with a conventional microscope, derives from the reduced width of hole 2133 and the low value for T(0), it is preferable to use a very bright light source 2130, for example an arc lamp.

For example, in this case the following can be used:
a Nikon CF160 planachromatic objective with digital aperture 1.25 forming the image at infinity and corrected independently of the tube lens, with focal length of 2 mm.
a Nikon planachromatic condenser with aperture 1.4 stepped down to 1.25, with focal length 8 mm.
a lens 1009 comprising a Melles Griot optimized achromatic doublet, with focal length 800 mm.
lenses 2134, 1016, 1017, 1020, 1025, 1032, 1047 and 1045 all identical to the tube lens used on Nikon microscopes, with focal length 200 mm.
a mercury arc lamp.
galvanometric mirrors with a diameter of approximately 20 mm.
a hole 2133 approximately 0.625 mm in diameter.
a filter plate defined as above with rₘₐₓ=2,5 mm and rₗᵢₘ=1,875 mm.

However, this sizing requires large-size galvanometric mirrors so as not to reduce the field. It is advantageous to modify the focal length of the lenses as follows:
lenses 1020, 1025, 1032, 1047 and 2134 to have a focal length of 50 mm,
lens 1009 to have a focal length of 200 mm, with other lenses remaining as described previously. This solution means smaller (approximately 6 mm) and faster galvanometric mirrors can be used, without having to reduce the size of the field. However, lenses with a focal length of 50 mm are more difficult to optimize avoiding aberrations.

In the configuration shown, the positions of lens 1032 and mirror 1033 have to be regulated accurately enough for the image plane to be fixed after reflection on the galvanometric mirrors. This can be slightly simplified by using a single galvanometric mirror mobile about two axes, with the other galvanometric mirror being replaced by a fixed mirror. In this case setting the position of mirror 1033 becomes irrelevant.

A change of objective in the device shown in FIG. 17 requires modifications to the rest of the optical system, which make a system adapted to a series of different objectives more expensive, in which the various lenses need to be replaced at the same time as the objective. However, the enhanced resolution the present invention makes possible is particularly useful with high resolution objectives. To limit cost and where the main aim of the device is to increase bright field resolution, it is advantageous to combine the present method, used for example with the x100 objective with oil or dry, with a conventional bright field microscopy method used with the other objectives. This can be done by sizing the system for the x100 objective and using the described method with this objective, implying appropriate control over the galvanometric mirrors allowing for scanning of the condenser object focal plane by the light beam. With the other objectives, hole 2133 is replaced by a diaphragm with sufficiently open aperture, a fixed position for the galvanometric mirrors is used, plates 1026,1027,1030 and polarizer 1031 are removed, and the polarization rotator is controlled so that it lets all light through, thus allowing a conventional bright field image to be obtained. It is also possible, though costlier, to use a partially distinct optical path for the conventional bright field and the enhanced resolution system.

### INDUSTRIAL APPLICATIONS

This microscope can be used to replace bright field, phase contrast and DIC microscopes. It offers much higher image quality, as well as the possibility of obtaining either sections or projections of the observed object.

I claim:

1. Microscope functioning in transmission, including a lighting source (2000) and a condenser (2011) allowing an observed object (2040) to be illuminated using a light beam not focused on the observed object, and a microscope objective (2012) collecting the light beam after it has passed through the observed object, characterized by the fact that it comprises:
a beam deflector (2003,2007) placed between the lighting source and the condenser, to vary the direction of the light beam in the observed object,
at least one lens (2018) to focus, at a first focusing point of a first focusing plane, the part of the light beam having passed through the observed object and the microscope objective that is not diffracted by the observed object,
a first filtering device (2019, 2047) placed in the first focusing plane, to apply a difference of phase and/or attenuation and/or of polarization within the first focusing plane, between on the one hand the non diffracted part of the light beam, which passes through the first focusing point, and on the other hand, the diffracted part of the light beam which does not pass through the first focusing point,
at least one first mobile mirror (2007, 2003) placed on the path of the light beam having passed through the observed object, between the objective and the first filtering device, to modify the direction of the light beam, so that the direction of the light beam, after reflection on the mobile mirror, is independent of the direction of the light beam in the observed object, and so that the first focusing point is fixed.

2. Microscope according to claim 1, wherein the beam deflector comprises at least one second mobile mirror (2007,2003) connected to said first mobile mirror or forming part of said first mobile mirror.

3. Microscope according to claim 2, wherein the first filtering device (2019,2047) is placed in a plane conjugate to the image focal plane of the microscope objective (2012).

4. Microscope according to claim 1, wherein transmissivity of the first filtering device (2047) depends on the distance to the optical axis, and is an increasing function of the distance to the optical axis, to improve resolution.

5. Microscope according to claim 1, wherein the first filtering device (2047,2019) includes a means to apply a phase shift between, on the one hand, the part of the light beam that passes through a central point coinciding with the first focusing point and, on the other hand, the part of the light beam that does not pass through the central point.

6. Microscope according to claim 5, wherein the means to apply a phase shift is an extra thickness (2411) added to a glass window (2403).

7. Microscope according to claim 1, wherein the first filtering device (2047,2019) includes a means to attenuate the part of the beam that passes through a central point coinciding with the first focusing point, to increase contrast of the image.

8. Microscope according to claim 7, wherein the means to attenuate is an absorbent material (2201) included in the filtering device (2047).

9. Microscope according to claim 1, wherein the light beam reaching the first filtering device is polarized, wherein the first filtering device includes a means (2019) to polarize differently the wave passing through, on the one hand, a central point (2101) coinciding with the first focusing point and, on the other hand, the remainder of the filtering device, so that polarization of the part of the light beam that passed through the central point differs from polarization of the part of the light beam that passed through the remainder of the filtering device, and including at least one polarizer (2023, 2028,2031) passed through by the beam having passed through the first filtering device, to make the part of the light beam that passed through the central point interfere with the part of the light beam that passed through the rest of the filtering device.

10. Microscope according to claim 9, including at least one retardation plate (2022,2027) placed on the path of the light beam between the first filtering device and the polarizer, to modify the phase variation between the beam having passed through the central point and the beam having passed through the rest of the filtering device.

11. Microscope according to claim 1, including:
at least three sensors (2024, 2029, 2032) on which interfere, on the one hand, the part of the light beam that was diffracted by the observed object and, on the other hand, the part of the light beam that was not diffracted by the observed object,
means (2022) to apply a first phase shift between, on the one hand, the part of the light beam that was diffracted by the observed object and that reaches a first sensor (2024) and, on the other hand, the part of the light beam that was not diffracted by the observed object and that reaches this first sensor,
means (2027) to apply a second phase shift, different from the first phase shift, between on the one hand, the part of the light beam that was diffracted by the observed object and that reaches a second sensor (2029) and, on the other hand, the part of the light beam that was not diffracted by the observed object and that reaches this second sensor to produce at least three interference figures allowing a complex image depending linearly on the characteristics of the observed object to be calculated.

12. Microscope according to claim 1, including at least one third mobile mirror (1005,1007) to modify the direction of the light beam after it was reflected on the first mobile mirror.

13. Microscope according to claim 12, wherein the third mobile mirror (1005,1007) is connected to the first mobile mirror (1007,1005) or is part of the first mobile mirror.

14. Microscope according to claim 13, including optical means so that an image of the observed object, after reflection by the first mobile mirror (1007,1005), passing through the filtering device (1026,1027), and reflection on the third mobile mirror (1005,1007), is fixed.

15. Microscope according to claim 14, characterized by the fact that said third mobile mirror is an opposite face of said first mobile mirror.

16. Microscope according to claim 15, wherein optical means used so that an image of the observed object, after reflection by the first mobile mirror and the third mobile mirror is fixed, comprise:
two lenses (1025,1032) or groups of lenses, separated by a focusing plane of the light beam,
an odd number of fixed mirrors (1004,1028,1029) deviating the beam in a first deviation plane, and an odd number of fixed mirrors (143,144,145,146,147) deviating the beam in deviation planes orthogonal to the first deviation plane.

17. Microscope according to claim 1, including at least one second filtering device (2046,1019)
placed in a second focusing plane of the light beam, reached by said light beam after having passed through the microscope objective and before reflection by said first mobile mirror,
adapted for applying a different change of phase and/or attenuation and/or of polarization to the light passing through different points of the second focusing plane, wherein the kind and/or magnitude of said change depends on the position of said points of the first focusing plane.

18. Microscope according to claim 17, wherein the second filtering device (2160) lets the light reaching an elliptic band (2161) pass and stops the light not reaching this elliptic band to produce an image with enhanced depth of field.

19. Microscope according to claim 18, wherein the second spatial filtering device (1019) includes means to let the light reaching one or the other of two distinct elliptic bands pass alternately, to produce alternately two images and thus form a stereoscopic image.

20. Microscope according to claim 18, wherein the elliptic band is circular.

21. Microscope according to claim 1, wherein the modification of phase and/or attenuation and/or of polarization is applied between on the one hand, the part of the light beam that passes through a central point coinciding with the first focusing point and, on the other hand, the part of the light beam that does not pass through the central point.

22. Microscope according to claim 1, wherein the light beam is parallel in the observed object.

23. Microscope according to claim 1, wherein the lighting source is a laser.

24. Microscope according to claim 1, comprising:
a two-dimensional detector (2192) placed in a plane conjugate to the image focal plane of the objective, to detect the light beam having passed through the observed object,
means (2190, 2194) for extracting, from the light beam having passed through the observed object, a reference beam made of part of the beam not diffracted by the observed object,
means (2197, 2191) for illuminating the entire surface of the two-dimensional detector with the reference beam, so that the reference beam interferes on the detector with the light beam having passed through the observed object.

25. Transmission microscope, comprising:
means for illuminating an observed object (2040) using a light beam not focused on the observed object,
means for collecting the light beam after it has passed through the observed object,
means for varying the direction of the light beam in the observed object,
means for focusing, at a first focusing point of a first focusing plane, the part of the light beam having passed through the observed object that is not diffracted by the observed object,
means for applying a different change of phase and/or attenuation and/or of polarization to the light passing through different points of the first focusing plane, wherein the kind and/or magnitude of said change depends on the position of said points of the focusing plane.
means for redirecting the light beam having passed through the observed object and propagating towards the first focusing plane, in a fixed direction independent of the direction of the light beam in the observed object, so that the first focusing point is fixed.

26. A method for generating an image of an observed object, comprising the steps of:
illuminating an observed object using a light beam not focused on the observed object,
collecting the light beam after it has passed through the observed object,
varying the direction of the light beam in the observed object,
focusing, at a first focusing point of a first focusing plane, the part of the light beam having passed through the observed object that is not diffracted by the observed object,
applying a different change of phase and/or attenuation and/or of polarization to the light passing through different points of the first focusing plane, wherein the kind and/or magnitude of said change depends on the position of said points of the focusing plane,
redirecting the light beam having passed through the observed object and propagating towards the first focusing plane, in a fixed direction independent of the direction of the light beam in the observed object, so that the first focusing point is fixed.
